(19) United States
(12) Patent Application Publication
(10) Pub. No.: US 2009/0063180 A1
(43) Pub. Date: Mar. 5, 2009

(54) METHOD TO ORGANIZE NATIONWIDE SPORTING EVENTS

(76) Inventor: THOMAS D. HATHAWAY, Oro Valley, AZ (US)

Correspondence Address: DALE F. REGELMAN, QUARLES & BRADY, LLP, ONE SOUTH CHURCH AVENUE AVE, STE. 1700, TUCSON, AZ, 85701-1621, US

(21) Appl. No.: 12/202,931

(22) Filed: Sep. 2, 2008

Related U.S. Application Data
(60) Provisional application No. 60/969,549, filed on Aug. 31, 2007.

(51) Int. Cl. G06Q 10/00; H04M 1/00

(52) U.S. Cl. 705/1; 455/456.1; 455/556.1

(57) ABSTRACT

A method to administer a sporting event sponsored by an Association, wherein the Association conducts a tournament and establishes a time period for the tournament. The method supplies a plurality of equipment items approved by the Association, wherein each equipment item recites a unique identifier and an Association trademark. An Association member enters the tournament by proffering at a tournament site an equipment item comprising an Association trademark. An Association member generates a score, that score is verified by an Association-approved referee, and the score is provided to the Association.

### CROSS-REFERENCE TO RELATED APPLICATION

This application incorporates by reference and claims priority to U.S. Provisional Application Ser. No. 60/969,549, which was filed on Aug. 31, 2007.

### FIELD OF THE INVENTION

This Application is directed to a method to organize nationwide sporting events.

### BACKGROUND OF THE INVENTION

There are 28 million golfers in the United States playing 500 million rounds of golf (an average of 17 rounds per golfer per year). According to the National Golf Foundation (NGF) a “core golfer” is one that averages 8 to 10 rounds per year. Interestingly, about 2.5 billion golf balls are used per year, but approximately 2.3 billion of those golf balls are lost every year.

An estimated 518 million rounds of golf are played in the United States each year. On average, a golfer loses 4.5 balls per round. As those skilled in the art will appreciate, in the game of golf the fewer strokes taken, and the fewer balls lost, the better the score and the better the golfer.

### SUMMARY OF THE INVENTION

Applicants invention includes a method to administer a sporting event sponsored by an Association, wherein the Association conducts a tournament and establishes a time period for the tournament. The method supplies a plurality of equipment items approved by the Association, wherein each equipment item recites a unique identifier and an Association trademark. An Association member enters the tournament by proffering at a tournament site an equipment item comprising an Association trademark. An (i)th Association member generates an (i)th score, that (i)th score is verified by an Association-approved referee, and the (i)th score is provided to the Association.

### BRIEF DESCRIPTION OF THE DRAWINGS

The invention will be better understood from a reading of the following detailed description taken in conjunction with the drawings in which like reference designators are used to designate like elements, and in which:

FIG. 1 is block diagram illustrating the elements of Applicant's hand-held wireless communication device; and

FIG. 2 illustrates certain additional elements of Applicants hand-held wireless communication device.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Applicant's invention includes creating and administrating a game governed by an association (the “Association”) to organize and promote nationwide and or international, sporting events, wherein any person may join the Association. The objective of the Game is to encourage better play, organization, profitability, relationships, sportsmanship, technology, the spirit of competitiveness.

Applicant's Association has no affiliation with, connection to, sponsorship by, or approval by, the PGA, LPGA, USGA, NCAA, or any other sport governing body. To the extent practicable, membership in the Association, and participation in Association events, will not contravene the rules of such independent sport governing bodies.

In certain embodiments, the Game is associated with a single sport. In certain embodiments, the Game is associated with multi-sport (golf basketball, bowling, football, chess, darts, any Olympian or any non-Olympian, virtual and non-virtual sport(s).

The following examples are presented to further illustrate to persons skilled in the art how to make and use the invention. These examples are not intended as a limitation, however, upon the scope of the invention.

### EXAMPLE I

### Golf

XGSTOUR is an international golf competition allowing members to compete on any public or private golf course at anytime anywhere. XGSTOUR “Side Game” allows personal, corporate and non-profit international tournaments any time on infinite number of golf courses worldwide.

Individuals establish golf handicaps while playing on handicapped golf courses.

How to Play: Players compete worldwide on multiple golf courses in ongoing golf tournament.

Log on to xgstour.com and join the ongoing tour (tour September 1 to August 31).

Play golf a minimum of 10 times during tour period with XGS approved balls at any private or public golf course(s).

XGS golf balls available only at xgstour.com.

Input golf scorecard to xgstour.com via phone or computer (keyboard or scan) for minimum of 10 rounds of golf.

No penalty for replacing worn or damaged XGS golf balls. Starter witnesses XGS golf ball to be played on the scorecard.

2-stroke penalty for lost ball. Input new ball and continue tournament. Subsequent balls are logged via golfer/witness.

Check xgstour.com for real-time game scores, tour leader rankings, member handicaps/profiles/statistics, news, email and much more.

How to play multiple balls at same time during the same ongoing tournament:

Enter new XGS golf ball as additional “Ball in Play” via xgstour.com and follow instructions.

Each “Ball in Play” must have minimum of 10 rounds of golf during tour period (September 1 to August 31) to qualify for that year's tournament.

How to play a “Side Game”:

Log on to xgstour.com and select “Side Game” following instructions.

Use Email tools at xgstour.com to email other friends and members the link to specific “Side Game” for them to join.

“Side Game” options include: Skins/Match play, Stableford, teams, number of rounds or duration of tour, private, non-profit, corporate tour etc).

### EXAMPLE II

### Bowling

XGSTOUR is an international bowling competition allowing members to compete on any public or private bowling lanes at anytime anywhere. XGSTOUR “Side Game” allows personal, corporate and non-profit international tournaments anytime on infinite number of bowling lanes worldwide.

Individuals establish bowling averages while playing on any public or private bowling lanes. Players compete worldwide on multiple bowling lanes in ongoing bowling tournament.

How to Play:

Log on to xgstour.com and join the ongoing tour (tour September 1 to August 31).

Bowl a minimum of 10 games during tour period with XGS approved balls at any private or public bowling lane(s).

XGS bowling balls available only at xgstour.com.

Input bowling scorecard to xgstour.com via phone or computer (keyboard or scan) for minimum of 10 games of bowling.

Starter witnesses XGS bowling ball to be played on the scorecard; balls are logged via bowler/witness.

Check xgstour.com for real-time game scores, tour leader rankings, member handicaps/profiles/statistics, news, email and much more.

How to play multiple balls at same time during the same ongoing tournament Enter new XGS bowling ball as additional “Ball in Play” via xgstour.com and follow instructions.

Each “Ball in Play” must have minimum of 10 games of bowling during tour period (September 1 to August 31) to qualify for that year's tournament.

How to play a “Side Game”:

Log on to xgstour.com and select “Side Game” and follow the instructions.

Use Email tools at xgstour.com to email other friends and members the link to specific “Side Game” for them to join.

Side Game” options include: Single, Doubles, Teams, number of games or duration of tour, private, non-profit, corporate tour etc.

As those skilled in the art will appreciate, in the game of golf there are approved balls. These balls must meet the standard of requirements for tournament play by the Professional Golfers Association (“PGA”). In golf-related embodiments, Association members must participate in Association events using Association approved golf balls, equipment and the like.

As a general matter, such Association approved golf balls are PGA compliant, and display an approved Association trademark and a unique identifier. In certain embodiments, such a unique identifier comprises a printed, machine-readable label, such as and without limitation a bar code.

In certain embodiments, when a Association member elects to play a round of golf that Association member may further elect to participate in the Association's Tournament(s). In these embodiments, the Association sponsors a mass competition tournament of golf that utilizes a unique Association approved rules of play (see Appendix B, C & D samples ). The Game's Rules may vary from tournament to tournament(s). The Game rules are for tournaments that can be ongoing with periodic winners.

The game begins by using Association balls, equipment purchased from retailers or special ordered. The Association balls comprise individually coded identifiable ball(s) that allow an Association member to enter an Association competition.

Association balls can be purchased from many manufacturers. In certain embodiments, the entry fee may be built into the total price of the Association ball. The price of the ball, or sleeve can be adjusted, based upon the level of game play. In these embodiments, the higher the entry fee an Association member pays the higher the payout to winners holding a professional or other than amateur status.

In certain embodiments, the Association comprises members holding either Amateur or Professional status. In other embodiments, Applicant's invention comprises two different Associations, i.e. an Association and an Association, i.e. an amateur Association and a professional Association.

In the dual Association embodiments, an Association member can start playing in the amateur league and if, in accord with spirit of generally accepted rules such as for golf, USGA progress to Association P. that member represents his or her country, or golf association, or age group, then that Association member can receive reimbursement of expenses. In addition, if an Association member holding amateur status competes and wins, the Association may reimburse that member for his or her total expenses for that season. Such an Association member may not receive finds above $750 under USGA amateur requirements. As those skilled in the art will appreciate, the USGA governs golf in United States. Other such associations govern golf in other locales.

In certain golf-related embodiments, Association members can play on any public or private course. The starter must initial the Association member's scorecard, and recite the ball identifier on that scorecard. When a ball is lost a two-stroke penalty is added to the Association member's card, and the replacement ball's identifier is verified and entered on scorecard. In certain embodiments, witness verification is required for game piece, golf ball for verification for initial, lost and replaced balls.

In certain embodiments, Association members compete not only to score points but also for one or more longevity factors associated with the golf ball(s) used. In certain embodiments, that longevity factor comprises the number of rounds of golf played using a single golf ball. In certain embodiments, that longevity factor comprises the number of yards traveled by a single ball. In certain embodiments, that longevity factor comprises the number of yards traveled by multiple played balls.

The Association's competitions take place over defined periods of time. All member information will be recited on “The Leader Board,” wherein that Leader Board comprises an online website maintained by the Association. Association members may check their progress, statistics, handicap (recognized by industry/courses), and other associated information, by accessing the Leader Board.

In certain embodiments, the Leader Board comprises a Reservation Service wherein Association members may make hotel, airfare, and auto rental bookings. In certain embodiments, the Leader Board comprises an online store where Association members can purchase Association merchandise. In certain embodiments, the Leader Board comprises a Forum or messaging facility, which Association members can use to communicate with one another. In certain embodiments, the Leader Board displays all competitions in play, information regarding competitions or games that have been played recently, and information regarding upcoming Association events.

In certain embodiments, the Leader Board comprises a map searching facility. In certain embodiments, the Leader Board comprises a Game Reservation facility, wherein Association members can reserve start times at golf clubs. In certain embodiments, the Leader Board comprises a Concierge Services facility, wherein Association members can purchase tickets for golf events and the like.

In certain embodiments, the Leader Board comprises a Video Hosting facility, wherein hosting services can be provided specifically for golf related videos. In certain embodiments, the Leader Board comprises a Virtual Course Tour, wherein golf clubs pay to have their club listed, and optionally to display a virtual tour of the club. In certain embodiments, the Leader Board comprises a Golf Masterclass Booking, wherein an Association member can book a professional for golf instruction and or critique. In certain embodiments, the Leader Board comprises a Player profile database, wherein Association members can review other members' information. In certain embodiments, the Leader Board comprises a Web Shop, wherein Association members can obtain merchandise, stock trade information, news, weather, auctioning services, classified ads, and the like.

Golf ball manufacturers, and other persons who custom order bulk Association balls, may charge Association members a purchase price sufficient to cover the cost of the balls, customization, licensing of Association trademarks, shipping, and handling of the balls. An Association entry fee is added to the purchase price of any Association-branded sports equipment, such as golf balls. This Association entry fee is paid directly to the Association at the point of sale/order.

In certain embodiments the Association entry fee covers the entry of the purchaser of that ball in the Association tournament, which is held annually (or periodically). The Association balls when purchased are registered via the Internet, mail, or fax, on the purchaser's “Players Board”. In certain embodiments individual Players Board may be accessed from the Association's Leader Board. Association members Players Board displays a comprehensive chart and scale of the statistics regarding that Association member, including for example handicap, courses played, scoring, total distance, and the like.

If an Association member wants to enter the data realized from playing a round of golf, that Association member must be current on his or her monthly fees. In certain embodiments, contingent upon timely payment of Association monthly fees, Association members can access information including personal profiles tracking Association member's handicap, email, links, and comments, game updates for other Association members, merchandise and stats from the Leader Board. In certain embodiments, contingent upon timely payment of Association monthly or annual fees, Association members may further enjoy Association email and information, statistics, education, member profile including recognized handicap provided.

In certain embodiments, the Association maintains separate categories for the Association members. In certain embodiments, these categories include Association balls, Non Association balls, single ball play, multiple ball play, Association GPS and Association non-GPS balls. In certain embodiments, each of these categories may be played at differing levels. In certain embodiments, this combination of categories and levels gives a total of 12 different competition embodiments. Prizes awarded for positions 1^{st}, 2^{nd}, 3^{rd} would total 36 winners. Prizes awarded up to and including the 10^{th} position would total 120 winners.

In certain embodiments, prizes awarded comprise, for example, an Association divot tool, cap, shirt, and the like. In certain embodiments, Association members may win prizes based upon their geographical locale, i.e. region-wide, state-wide, city-wide, In certain embodiments, Association members may compete based upon age categories. As those skilled in the art will appreciate, Association members may participate in a nation-wide competition, wherein that competition takes place over several months, and wherein the Association members may review their individual standing at any time on the Leader Board, and wherein several hundred Association members may eventually win an Association prize for their participation.

In certain embodiments, the Leader Board will recite the manufacturer of the golf ball and Association member currently holding the greatest longevity factor, as described herein above. These commercial organizations have the opportunity to sponsor Association tournaments and Association members.

In certain embodiments, the Association sells in commerce certain hand-held wireless communication devices. In certain embodiments, Applicant's hand-held wireless communication device is selected from the group consisting of a cellular telephone, a personal digital assistant (“PDA”), a key fob, a digital music player, and combinations thereof. In certain embodiments, Applicant's hand-held wireless communication device comprises a cell phone, scorecard, rangefinder, and navigation device, such as for example a global positioning satellite (“GPS”) device which is capable of determining the location of the GPS navigation module by receiving and processing a plurality of satellite signals.

Many of the functional units disposed in Applicant's hand-held wireless device have been labeled as modules (e.g., modules 140, 150, and 190) in order to more particularly emphasize their implementation independence. For example, a module (e.g., modules 140, 150, and/or 190) may be implemented as a hardware circuit comprising custom VLSI circuits or gate arrays, off-the-shelf semiconductors such as logic chips, transistors, or other discrete components. A module (e.g., modules 140, 150, and/or 190) may also be implemented in programmable hardware devices such as field programmable gate arrays, programmable array logic, programmable logic devices, or the like.

Modules (e.g., modules 140, 150, and/or 190) may also be implemented in software for execution by various types of processors. An identified module of executable code may, for instance, comprise one or more physical or logical blocks of computer instructions which may, for instance, be organized as an object, procedure, or function. Nevertheless, the executables of an identified module (e.g., 140, 150, and/or 190) need not be physically collocated, but may comprise disparate instructions stored in different locations which, when joined logically together, comprise the module and achieve the stated purpose for the module.

Indeed, a module of executable code (e.g., modules 140, 150, and/or 190) may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

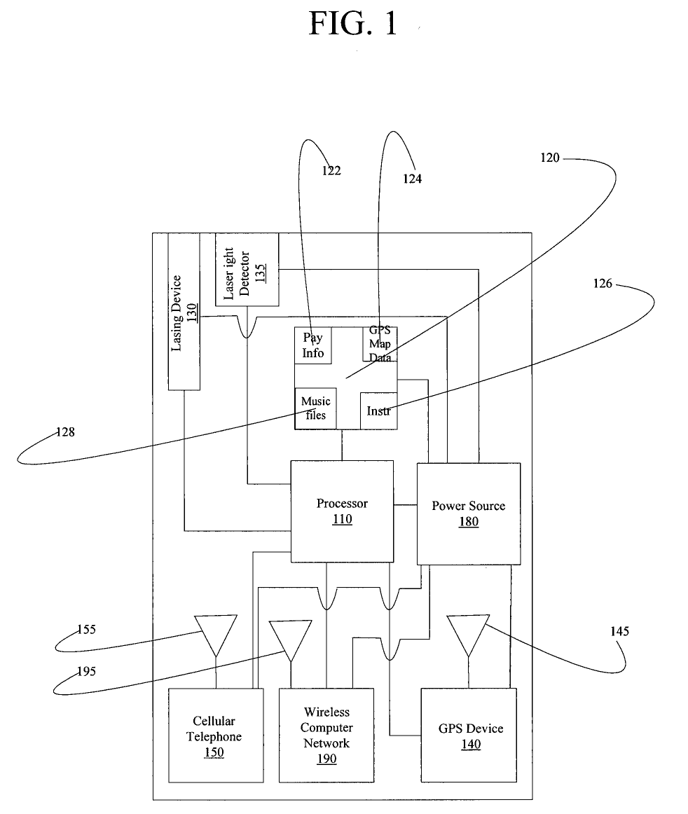

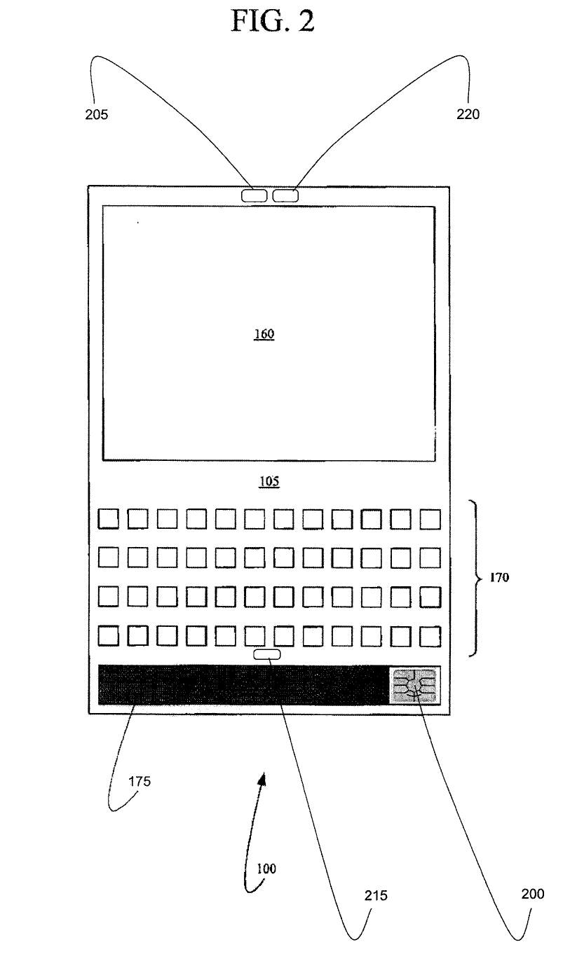

Referring now to FIGS. 1 and 2, Applicant's hand-held device 100 comprises housing 105, visual display device 160, data input device 170, retractable Magnetic strip (with user financial/bank/credit card account number(s), expiration date(s), security code(s) encoded therein) 175, integrated circuit chip 200, speaker 205, microphone 215 and camera 220. In the illustrated embodiment of FIG. 2, data input device 170 comprises a plurality of buttons. In other embodiments, data input device 170 comprises a plurality of touch screens. In other embodiments, data input device 170 comprises one or more pointing devices.

Applicant's hand-held device 100 further comprises processor 110, memory 120, lasing device 130, laser light detector 135, GPS navigation module 140, cellular telephone module 150, power source 180, and wireless computer network interface module 190.

In certain embodiments, integrated circuit chip is integral with processor 110. In certain embodiments, speaker 205 is interconnected with processor 110 and/or integrated circuit chip 200. In certain embodiments, microphone 215 and speaker 205 are interconnected with cellular telephone module 150. In certain embodiments, camera 220 is interconnected with memory 120.

In the illustrated embodiment of FIG. 1, a user's payment information 122, such as and without limitation, credit card account number(s), credit card PIN number(s), are encoded in memory 120. In the illustrated embodiment of FIG. 1, GPS mapping data, such as and without limitation golf course(s) configuration(s) including three-dimensional maps, are encoded in memory 120. In the illustrated embodiment of FIG. 1, instructions/operating system 126 are encoded in memory 120. Processor 110 utilizes instructions/operating system 126 to operate Applicant's hand-held device 110. In the illustrated embodiment of FIG. 1, music files, such as and without limitation MP3 files, are encoded in memory 120.

In certain embodiments, Applicant's hand-held device 100 further comprises antenna 145 which is interconnected with GPS navigation module 140. In certain embodiments, Applicant's hand-held device 100 further comprises antenna 155 which is interconnected with cellular telephone module 150. In certain embodiments, Applicant's hand-held device 100 further comprises antenna 195 which is interconnected with wireless computer network interface module 190.

Visual display device is interconnected with processor 110 and power source 180. Speaker 205 is interconnected with processor 110 and memory device 120. Data input device 170 is interconnected with processor 110.

Lasing device 130 in combination with laser light detector 135 comprises a laser rangefinder device which uses a laser beam emitted from lasing device 130 to determine a distance to a reflective object. Applicant's hand-held device 100 operates on a time of flight principle by sending a laser pulse in a narrow beam towards an object, detecting using laser light detector 135 a reflected beam, and measuring a time taken by the pulse to be reflected off the target and returned to the sender.

In certain embodiments, Applicant's hand-held wireless communication device 100 facilitates electronic scorecard posting to the Internet, and/or the use of Bluetooth stereo eyewear. In certain embodiments, Applicant's hand-held wireless communication device 100 audibly emits, using speaker 205 MP3 music, golf instruction, and or distance alerts regarding the distance from a pin.

Certain hand-held wireless communication device attributes and or capabilities can be purchased “on demand,” wherein the user wirelessly purchases, or upgrades, the available features of Applicant's hand-held wireless communication device. In certain embodiments, the user's payment authorization data/features are encoded in a memory device 120 disposed in Applicant's hand-held wireless communication device 100. Such payment authorization data/features comprise, for example and without limitation, the user's credit card number, expiration date, security code, digital certificate, and the like. In certain embodiments, the user must manually enter a password, personal identification number, or the like, to wireless purchase, or upgrade, one or more features of Applicant's hand-held wireless communication device 100.

In certain embodiments, the Association sells in commerce certain Smart Clubs, wherein a golf club is selected and information sent via wireless signals to Applicant's hand-held wireless communication device 100 which can audibly relay to eyewear/speakers information including but not limited to suggested club speed, actual club speed, quadrant of impacts, angle on impact, grip sensitivity, and the like. In certain embodiments, Applicant's hand-held wireless communication device 100 works in conjunction with Association balls comprising a GPS tracking circuit disposed therein.

In certain embodiments, the Association sells in commerce certain merchandize including golf clubs, gloves, tees, divot tools, ball markers, caps, rangefinders. In certain embodiments, the Association sells in commerce certain education services, including golf instruction, golf academies including hands on training, software, books, pamphlets. In certain embodiments, the Association makes employment offers to winners.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A method to administer a sporting event, comprising:
forming an Association comprising a membership;
conducting a tournament by said Association;
establishing a time period for said tournament;
supplying a plurality of equipment items approved by said Association, wherein a each equipment item recites a unique identifier and an Association trademark;
entering said tournament by an Association member, wherein said Association member enters said tournament by proffering at a tournament site an equipment item comprising an Association trademark, wherein (i) is greater than or equal to 1;
generating a score by said Association member;
verifying said score by an Association-approved referee;
providing said verified score to said Association.

2. The method of claim 1, further comprising:
verifying the authenticity of said equipment item comprising said unique identifier by an Association-approved referee;
associating said Association member with said equipment item comprising said unique identifier.

3. The method of claim 1, wherein said plurality of equipment items is selected from the group consisting of baseballs, darts, basketballs, shuttlecocks, gloves, shoes, swim suits, bowling balls, and bicycle helmets.

4. The method of claim 1, wherein:
said tournament comprises a golf tournament;
said plurality of equipment items comprises a plurality of golf balls.

5. The method of claim 4, wherein each of said plurality of golf balls comprises a GPS tracking circuit.

6. The method of claim 4, wherein said membership comprises:
a first plurality members each comprising a professional golfer;
a second plurality of members each comprising an amateur golfer.

7. The method of claim 6, further comprising selecting a tournament site by said Association member.

8. The method of claim 7, further comprising completing said tournament by said Association member within said time period.

9. The method of claim 4, wherein said Association member uses a designated golf ball during said gold tournament, wherein said generating step comprises establishing a longevity factor for said designated gold ball.

10. The method of claim 9, wherein said longevity factor comprises a number of rounds played by said Association member using said designated golf ball.

11. The method of claim 9, wherein said longevity factor comprises a number of yards traveled by said designated golf ball during said golf tournament.

12. The method of claim 11, wherein said longevity factor comprises a number of yards traveled by said designated golf ball during said golf tournament in combination with a number of aggregate yards traveled by said designated gold ball in earlier Association-sponsored golf tournaments.

13. A hand-held wireless communication device, comprising:
a power source;
a processor, interconnected with said power source;
a memory interconnected with said processor and said power source;
a lasing device interconnected with said processor and said power source;
a laser light detector interconnected with said processor and said power source;
a GPS navigation module interconnected with said processor and said power source;
GPS mapping data comprising a golf course configuration encoded in said memory.

14. The hand-held wireless communication device of claim 13, further comprising an antenna interconnected to said GPS navigation module.

15. The hand-held wireless communication device of claim 13, further comprising a cellular telephone interconnected with said processor and said power source.

16. The hand-held wireless communication device of claim 15, further comprising an antenna interconnected with said cellular telephone.

17. The hand-held wireless communication device of claim 15, further comprising a wireless computer network interface interconnected with said processor and said power source.

18. The hand-held wireless communication device of claim 17, further comprising an antenna interconnected with said wireless computer network interface.

19. The hand-held wireless communication device of claim 17, further comprising:
a speaker interconnected with said processor;
music files encoded in said memory.

20. The hand-held wireless communication device of claim 19, further comprising a user's credit card account number and credit card PIN number encoded in said memory.
